(19) United States
(12) Patent Application Publication
(10) Pub. No.: US 2011/0033646 A1
(43) Pub. Date: Feb. 10, 2011

(54) PROCESS FOR MAKING FIBER REINFORCED PLASTIC PIPE

(75) Inventors: Asjad Shafi, Lake Jackson, TX (US); Rajesh Turakhia, Lake Jackson, TX (US); John Beckerdite, Lake Jackson, TX (US); Michael Ross, Angleton, TX (US)

Correspondence Address: The Dow Chemical Company, P.O. BOX 1967, 2040 Dow Center, Midland, MI, 48641, US

(73) Assignee: DOW GLOBAL TECHNOLOGIES INC., Midland, MI (US)

(21) Appl. No.: 12/935,397

(22) PCT Filed: Jan. 30, 2009
(86) PCT No.: PCT/US2009/032594

§ 371 Date: Sep. 29, 2010

Related U.S. Application Data
(60) Provisional application No. 61/044,579, filed on Apr. 14, 2008.

(51) Int. Cl. B32B 1/08; B29C 70/16; B29C 70/30; B29C 70/84; B32B 1/02

(52) U.S. Cl. 428/36.9; 156/172; 428/35.7

(57) ABSTRACT

An improved process for making fiber reinforced epoxy plastic structure by a process that includes the steps of : forming a structure of the reinforcing fibers (14) an epoxyresin composition (15) that includes a liquid epoxy resin and an epoxy resin hardener; and heating the structure to cure the epoxy resin composition. The epoxy resin composition including more than one and one half percent of mono hydrolyzed epoxy resin and an epoxy resin hardener so that the viscosity of the epoxy resin composition during the heating step is in a range that results in a degree of impregnation of the void space between the reinforcing fibers by the cured epoxy resin composition that is greater than ninety volume percent of the void space.

### BACKGROUND OF THE INVENTION

The instant invention is in the field of fiber reinforced epoxy plastic pipe. More specifically the instant invention relates to the use of modified epoxy resins in the manufacture of such pipe.

Fiber reinforced plastic pipe is superior to pipe made of a metal, such as steel, for many applications. U.S. Pat. Nos. 3,933,180; 3,956,051; 4,139,025; 4,217,158; 4,361,459; 6,350,204; 6,736,168; and 6,889,716 describe various methods for making fiber reinforced plastic pipe.

As described in U.S. Pat. No. 5,106,443, in one method for making pipe by the filament-winding method, continuous glass fibers provided with an epoxy resin composition are continuously wound onto a rotating mandrel which determines the inside diameter of the pipe. The pipe wall is built up in layers, the impregnated fibers being first laid down one next to the other over the entire length of the pipe before the next layer is wound on top of it in the same manner. After the desired pipe-wall thickness has been reached, the filament-wound structure is subjected to an increasing temperature gradient to cure the epoxy resin composition, following which the structure is stripped from the mandrel. The viscosity of the epoxy resin composition decreases as it is heated and then increases as the epoxy resin composition cures. The initially decreased viscosity of the epoxy resin composition facilitates optimum impregnation of and coating of the glass fibers by the epoxy resin composition. However, if the initially decreased viscosity of the epoxy resin composition is too low, then the epoxy resin composition will drip from the glass fibers and the quality of the finished pipe will be decreased. And, if the initially decreased viscosity of the epoxy resin composition is too high, then the epoxy resin composition will not completely impregnate the glass fibers and the quality of the finished pipe will be decreased. The above-mentioned U.S. Pat. No. 5,106,443 disclosed an epoxy resin composition comprising a unique curing agent to optimize such a process. It would be an advance in the art if an epoxy resin composition comprising a modified liquid epoxy resin could be discovered to optimize such a process.

### SUMMARY OF THE INVENTION

The instant invention is the discovery that epoxy resin compositions comprising a sufficient amount of partially hydrolyzed epoxy resin can be used to optimize a process for making fiber reinforced epoxy plastic structures. More specifically, the instant invention is a method for making fiber reinforced epoxy structure by a process comprising the steps of: forming a structure comprising reinforcing fibers and an epoxy resin composition comprising a liquid epoxy resin and an epoxy resin hardener; and heating the structure to cure the epoxy resin composition, wherein the improvement is the epoxy resin composition comprising more than one and one half percent of mono hydrolyzed epoxy resin and an epoxy resin hardener so that the viscosity of the epoxy resin composition during the heating step is in a range that results in a degree of impregnation of the void space between the reinforcing fibers by the cured epoxy resin composition that is greater than ninety volume percent of the void space.

In one embodiment, the epoxy resin composition comprises more than two percent of mono hydrolyzed epoxy resin.

In another embodiment, the epoxy resin composition comprises less than five percent of mono hydrolyzed epoxy resin.

In a preferred embodiment, the stochiometric ratio of reactive groups of the epoxy resin composition to reactive groups of the epoxy resin hardener by equivalents is in the range of from about 1:0.9 to about 1:1.3.

In another preferred embodiment, the liquid epoxy resin has an epoxide equivalent weight in the range of from 175 to 500 grams per mole and a viscosity at 25° C. of from about 9,000 to about 20,000 cps.

The instant invention is also related to a structure made by any of the processes of the instant invention. In one embodiment, the structure is selected from the group consisting of a pipe, a vessel or tank, a boat hull, a propeller and a wind turbine blade.

### BRIEF DESCRIPTION OF THE DRAWINGS

FIG. 1 is a cross-sectional view of a web of glass fibers impregnated with an epoxy resin composition which becomes so thin upon heating to cure the epoxy resin composition that it drips from the web of glass fibers;

FIG. 2 is a cross-sectional view of a web of glass fibers partially impregnated with an epoxy resin composition which does not become thin enough upon heating to completely impregnate the web of glass fibers; and

FIG. 3 is a cross-sectional view of a web of glass fibers completely impregnated with an epoxy resin composition which has a viscosity when heat cured so that the cured epoxy resin composition completely fills the void space between the glass fibers.

### DETAILED DESCRIPTION

The instant invention is an improved method for making fiber reinforced epoxy structure by a process comprising the steps of: forming a structure comprising reinforcing fibers and an epoxy resin composition comprising a liquid epoxy resin and an epoxy resin hardener; and heating the structure to cure the epoxy resin composition, wherein the improvement is the epoxy resin composition comprising more than one and one half percent of mono hydrolyzed epoxy resin and an epoxy resin hardener so that the viscosity of the epoxy resin composition during the heating step is in a range that results in a degree of impregnation of the void space between the reinforcing fibers by the cured epoxy resin composition that is greater than ninety volume percent of the void space. The reinforcing fiber used in the instant invention is ordinarily glass or carbon fiber but any suitable reinforcing fiber (such as KEVLAR brand fiber from DuPont) can be used. The structure can be of any desired shape such as, and without limitation thereto, a pipe, a vessel or tank, a boat hull, a propeller and a wind turbine blade. The epoxy resin compositions of the instant invention can be cured by any suitable means such as by curing in or against a mold (such as by the “scrim process” where uncured resin passes through a screen to impregnate reinforcing fibers positioned on a form or mold) or by curing on a form or mandrel. The epoxy resin hardener or curing agent can be any suitable hardener such as the hardeners described in the publication DOW LIQUID EPDXY RESINS available on the world wide web at; www.dow.com/PublishedLiterature/dh_{—}0030/0901b8038003041c.pdf?filepath=epoxy/pdfs/noreg/296-00224.pdf&fromPage=GetDoc.

Partially hydrolyzed epoxy resins are described in U.S. Pat. Nos. 4,145,324; 4,348,505; 4,358,577; and 4,724,253. Partially hydrolyzed epoxy resins terminate at one end thereof with an epoxy group and at the other end thereof with a hydrolyzed epoxy group, i.e., a glycol group. The percent mono hydrolyzed epoxy resin is determined and defined herein as the peak area percent of mono hydrolyzed epoxy resin in an epoxy resin sample by reverse phase liquid chromatography using UV detection at 254 nanometers. Partially hydrolyzed epoxy resins are ordinarily mixed with an epoxy hardening agent (and optionally other ingredients such as a hardening catalyst) to form an epoxy resin composition to be cured or hardened by heating. D.E.R. 331 brand liquid epoxy resin from The Dow Chemical Company of Midland, Michigan is an example of a commercially available partially hydrolyzed epoxy resin wherein the percent mono hydrolyzed epoxy resin is about 4.8%.

An important benefit of the instant invention is the discovery that the time needed to make a fiber reinforced epoxy structure can be reduced by the use of a sufficient amount of mono hydrolyzed epoxy resin in the liquid epoxy resin composition. An even further reduction in the time needed to make a fiber reinforced epoxy structure can be achieved according to the instant invention by reducing the initial temperature of the liquid epoxy resin composition and increasing the final temperature of curing of the liquid epoxy resin composition as described in the following Example section.

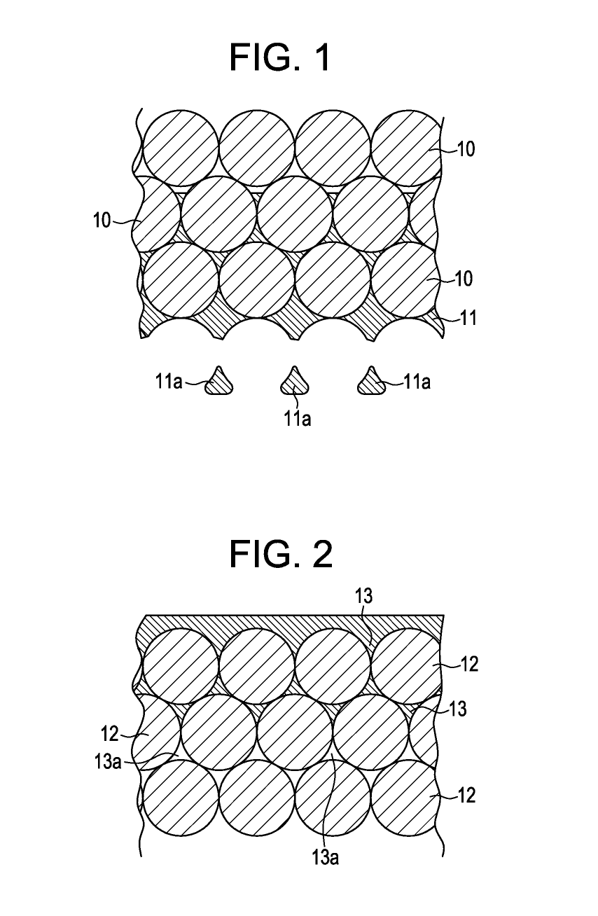

Referring now to FIG. 1, therein is shown a cross-sectional view of a web of glass fibers 10 impregnated with an epoxy resin composition 11 which becomes so thin upon heating to cure the epoxy resin composition that it drips, as droplets 11a, from the web of glass fibers 10.

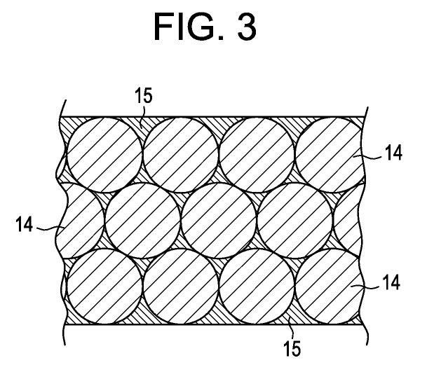

Referring now to FIG. 2, therein is shown a cross-sectional view of a web of glass fibers 12 partially impregnated with an epoxy resin composition 13 which does not become thin enough upon heating to completely impregnate the web of glass fibers 12 leaving some void spaces 13a between the fibers 12. Referring now to FIG. 3, therein is shown a cross-sectional view of a web of glass fibers 14 completely impregnated with an epoxy resin composition 15 which has a viscosity when heat cured so that the cured epoxy resin composition 15 completely fills the void space between the glass fibers 14.

### EXAMPLE

Four epoxy resin compositions (Compositions 1, 2, 3 and 4) are prepared. Composition #1 consists of 100 parts by weight (pbw) of Epikote 827 brand liquid epoxy resin (Hexion Specialty Chemicals, Columbus, Ohio) blended with 27.4 pbw of Anchamine DL 50 brand epoxy resin hardener (Air Products and Chemicals, Inc., Allentown, Ohio). Composition #2 consists of 100 pbw of D.E.R. 331 brand liquid epoxy resin (The Dow Chemical Company, Midland, Mich.) blended with 27.4 pbw of Anchamine DL 50 brand epoxy resin hardener. Composition #3 consists of 100 pbw of D.E.R. 383 brand liquid epoxy resin blended with 32 pbw of Anchamine DL 50 brand epoxy resin hardener. Composition #4 consists of 100 pbw of D.E.R. 383 brand liquid epoxy resin blended with 27.4 pbw of Anchamine DL 50 brand epoxy resin hardener.

Epikote 827 brand liquid epoxy resin contains about 1.3% mono hydrolyzed epoxy resin. D.E.R. 331 brand liquid epoxy resin contains from 4.5 to 5% mono hydrolyzed epoxy resin. D.E.R. 383 brand liquid epoxy resin contains about 0.5% mono hydrolyzed epoxy resin.

Composition #1 is used to make a glass fiber wound epoxy plastic pipe by winding continuous glass fibers onto a mandrel with the epoxy resin composition at a temperature of 70° C. followed by a linear temperature gradient of from 70° C. to 150° C. over a ten minute period of time. The viscosity of the epoxy resin composition initially falls from 0.2 Pa-seconds at the start of the heating gradient to a minimum of 0.01 Pa-seconds after eight minutes of the heating gradient, then to a viscosity of 0.02 Pa-seconds at the end of the heating gradient and finally to an infinite viscosity after five minutes additional heating at 150° C. The time needed to react 98 mole percent of the epoxy groups of the epoxy composition with the hardening agent is greater than 120 minutes. The resulting glass fiber wound epoxy plastic pipe is tested for the degree of impregnation of the void space between the reinforcing fibers by the cured epoxy resin composition by weighing a known volume of a representative sample cut from the pipe. The degree of impregnation of the void space between the reinforcing fibers by the cured epoxy resin composition is greater than ninety volume percent of the void space.

Composition #2 is used to make a glass fiber wound epoxy plastic pipe by winding continuous glass fibers onto a mandrel with the epoxy resin composition at a temperature of 70° C. followed by a linear temperature gradient of from 70° C. to 150° C. over a ten minute period of time. The viscosity of the epoxy resin composition initially falls from 0.2 Pa-seconds at the start of the heating gradient to a minimum of 0.02 Pa-seconds after six minutes of the heating gradient, then to a viscosity of 0.2 Pa-seconds at the end of the heating gradient and finally to an infinite viscosity after five minutes additional heating at 150° C. The time needed to react 99 mole percent of the epoxy groups of the epoxy composition with the hardening agent is 43 minutes. The resulting glass fiber wound epoxy plastic pipe is tested for the degree of impregnation of the void space between the reinforcing fibers by the cured epoxy resin composition by weighing a known volume of a representative sample cut from the pipe. The degree of impregnation of the void space between the reinforcing fibers by the cured epoxy resin composition is greater than ninety volume percent of the void space.

Composition #2 is also used to make a glass fiber wound epoxy plastic pipe by winding continuous glass fibers onto a mandrel with the epoxy resin composition at a temperature of 60° C. followed by a linear temperature gradient of from 60° C. to 170° C. over a ten minute period of time. The viscosity of the epoxy resin composition falls to a viscosity of 0.014 Pa-seconds at the end of the heating gradient and finally to an infinite viscosity after five minutes additional heating at 170° C. The time needed to react 98 mole percent of the epoxy groups of the epoxy composition with the hardening agent is 33 minutes. The resulting glass fiber wound epoxy plastic pipe is tested for the degree of impregnation of the void space between the reinforcing fibers by the cured epoxy resin composition by weighing a known volume of a representative sample cut from the pipe. The degree of impregnation of the void space between the reinforcing fibers by the cured epoxy resin composition is greater than ninety volume percent of the void space. Thus, a further reduction in the time needed to make a fiber reinforced epoxy structure can be achieved according to the instant invention by reducing the initial temperature of the liquid epoxy resin composition and increasing the final temperature of curing of the liquid epoxy resin composition

Composition #3 is used to make a glass fiber wound epoxy plastic pipe by winding continuous glass fibers onto a mandrel with the epoxy resin composition at a temperature of 70° C. followed by a linear temperature gradient of from 70° C. to 150° C. over a ten minute period of time. The viscosity of the epoxy resin composition initially falls from 0.2 Pa-seconds at the start of the heating gradient to a minimum of 0.01 Pa-seconds after eight minutes of the heating gradient, then to a viscosity of 0.02 Pa-seconds at the end of the heating gradient and finally to an infinite viscosity after five minutes additional heating at 150° C. The time needed to react 98 mole percent of the epoxy groups of the epoxy composition with the hardening agent is greater than 120 minutes. The resulting glass fiber wound epoxy plastic pipe is tested for the degree of impregnation of the void space between the reinforcing fibers by the cured epoxy resin composition by weighing a known volume of a representative sample cut from the pipe. The degree of impregnation of the void space between the reinforcing fibers by the cured epoxy resin composition is greater than ninety volume percent of the void space.

Composition #4 is used to make a glass fiber wound epoxy plastic pipe by winding continuous glass fibers onto a mandrel with the epoxy resin composition at a temperature of 70° C. followed by a linear temperature gradient of from 70° C. to 150° C. over a ten minute period of time. The viscosity of the epoxy resin composition initially falls from 0.2 Pa-seconds at the start of the heating gradient to a minimum of 0.007 Pa-seconds after eight minutes of the heating gradient, then to a viscosity of 0.01 Pa-seconds at the end of the heating gradient and finally to an infinite viscosity after five minutes additional heating at 150° C. The time needed to react 98 mole percent of the epoxy groups of the epoxy composition with the hardening agent is greater than 120 minutes. The resulting glass fiber wound epoxy plastic pipe is tested for the degree of impregnation of the void space between the reinforcing fibers by the cured epoxy resin composition by weighing a known volume of a representative sample cut from the pipe. The degree of impregnation of the void space between the reinforcing fibers by the cured epoxy resin composition is less than ninety volume percent of the void space because the epoxy resin composition dripped from the void space between the glass fibers during the heat curing of the epoxy resin composition.

1. A process for making a fiber reinforced epoxy structure comprising the steps of:
(a) impregnating reinforcing fibers with an epoxy resin composition; wherein the epoxy resin composition comprises a liquid epoxy resin and an epoxy resin hardener;
(b) winding the impregnated fibers of step (a) over a form or a mandrel ; and
(c) curing the epoxy resin composition;
wherein the epoxy resin composition comprises more than one and one half percent of mono hydrolyzed epoxy resin; wherein the viscosity of the epoxy resin composition during the curing is sufficient to impregnate the void space between the reinforcing fibers and the cured epoxy resin composition; and wherein the impregnated fibers have a degree of impregnation of void space between the reinforcing fibers by the cured epoxy resin composition greater than ninety volume percent of the void space.

2. The process of claim 1, wherein the epoxy resin composition comprises more than two percent of mono hydrolyzed epoxy resin.

3. The process of claim 2, wherein the epoxy resin composition comprises less than five percent of mono hydrolyzed epoxy resin.

4. The process of claim 1, wherein the stoichiometric ratio of reactive groups of the epoxy resin composition to reactive groups of the epoxy resin hardener by equivalents is in the range of from about 1:0.9 to about 1:1.3.

5. The process of claim 1, wherein the liquid epoxy resin has an epoxide equivalent weight in the range of from about 175 to about 500 grams per mole and a viscosity at 25° C. of from about 9,000 to about 20,000 cps.

6. A structure made by the process of claim 1.

7. The structure of claim 6, wherein the structure is selected from the group consisting of a pipe, a vessel, a tank, a boat hull, a propeller and a wind turbine blade.

8. The process of claim 1, wherein the impregnated fibers are cured while on the mandrel in step (b).

9. The process of claim 1, wherein the impregnated fibers are cured after winding step (b) and after removal from the mandrel.
